(19) United States
(12) Patent Application Publication
(10) Pub. No.: US 2009/0014371 A1
(43) Pub. Date: Jan. 15, 2009

(54) Storm drain filter for erosion control

(76) Inventor: Duane E. Cook, Mira Loma, CA (US)

Correspondence Address: GALLAGHER & KENNEDY, P. A., 2575 E. CAMELBACK RD. #1100, PHOENIX, AZ, 85016, US

(21) Appl. No.: 12/214,722

(22) Filed: Jun. 20, 2008

Related U.S. Application Data
(60) Provisional application No. 60/936,911, filed on Jun. 22, 2007.

(51) Int. Cl. E03F 1/00; B01D 35/02

(52) U.S. Cl. 210/164; 210/170.03

(57) ABSTRACT

There is provided a storm drain filter that includes bristles, an arm, a frame, and a means for attaching the frame to a storm drain. Where the filter is to be used with a curb-side drain having a concrete enclosure, the filter may include concrete bolts to secure the frame to an inner surface of the drain enclosure. The frame is flexible so that once the frame is secured to the drain structure, the frame can be adjusted in order to allow the filter bristles to cover the drain opening.

### CROSS REFERENCE TO RELATED APPLICATIONS

This application claims priority from the provisional patent application Ser. No. 60/936,911 filed Jun. 22, 2007 in the name of Duane E. Cook entitled “Storm Drain Filter for Erosion Control” incorporated herein by reference.

### FIELD OF THE INVENTION

The present invention relates to erosion control devices. More particularly, the invention relates to brush filters for use in filtering dirt and other contaminants from water flowing from construction sites so as to prevent the entry of such materials into drainage systems.

### BACKGROUND OF THE INVENTION

Water management systems and drainage systems can suffer clogs, back ups, and poor performance when water borne debris and foreign materials are allowed to accumulate in the drainage system. Construction sites in particular can give rise to the presence of debris, contaminants, and miscellaneous solid pollutants that tend to be collected in water run off; and it is generally undesirable in a water drainage system for a variety of reasons, including performance of the system and water quality, that these contaminants be allowed to accumulate in the drainage system. Hence it would be desired to provide a means of preventing these materials from entering into a drainage system.

A particular form of drainage system includes a curb-side drain entry. A typical and quickly recognized form of curb-side drain is illustrated in FIG. 11. Curb-side drains are often present in or near urban areas where there has been a degree of development. The illustrated curb-side drain includes an opening that is structured to run along the vertical face of road-side curb. Civil engineers design the curb and road with a desired slope so that water typically travels in the channel provided at the road/curb intersection. This channel is further sloped so that water is directed to the drain opening. Upon reaching the drain opening, water then passes from the curb channel through the opening, and into other drainage and piping systems positioned below the road surface. Water is then moved through this drainage system to a desired water control location such as flood control channels or containment ponds. The typical curb-side drain is a concrete structure.

The curb-side drain and the drainage system to which it is attached can also suffer clogging and obstruction from contaminants carried in the water. Features of this kind of system also leave it vulnerable to poor or degraded operation due to siltification. In particular the opening of the curb-side drain presents a drainage area with a limited area. The slope of the drain pipes in the drainage system can sometimes allow sand and silt to fall out the water stream thus blocking water flow, or, more insidiously, dangerously slowing water flow during times of heavy volume such as when flooding rains occur. Thus, for all these reasons, it would be desired to provide a means to limit the passage of sand, silt, and water born contaminants into a curb-side drain.

Hence there has been identified a need to provide an improved curb-side filter design as well systems and methods of employing and utilizing filter designs. For example, it is desired that an improved curb-side filter be inexpensive, robust, and adaptable to varying curb and gutter shapes and configurations. It is further desired that an improved filter reduce the amount of sand, silt, and contaminants that pass from a gutter into a drainage system. Additionally, it would be desired that an improved curb-side filter be designed so that it could be retrofit onto existing curb and drain structures. The embodiments of the present invention disclosed herein address one or more of these long felt but unmet needs.

### SUMMARY OF THE INVENTION

In one embodiment, and by way of example only, there is provided a filtration apparatus for use with a curbside drain comprising: a frame comprising a holding rail and an attaching flange, a plurality of concrete bolts affixed to the attaching flange, a broom filter comprising a plurality of bristles having a proximal end and a distal end, and an arm wherein the plurality of bristles are affixed to the arm at their proximal end, wherein the arm is secured within the holding rail of the frame and wherein the bristles extend substantially vertically from the arm. The curbside drain may have an inner surface and wherein the concrete bolts are affixed to the inner surface of the curbside drain so that water passing into the curbside drain passes through the broom filter. The curbside drain may also have an opening and wherein the frame is attached to the curbside drain so that the broom filter substantially covers the opening. The bristles may comprise polypropylene fibers. Alternatively, the bristles may comprise synthetic fibers. Also alternatively, the bristles may comprise natural fibers. The frame may further comprise at least one side arm affixed to the attaching rail. The holding rail may be affixed to the attaching flange by means of fasteners such as rivets.

In a further embodiment, still by way of example only, there is provided an apparatus for erosion control comprising a frame, a filter affixed to the frame, and an attachment means affixed to the frame. The frame may include a top rail and wherein the attachment means is affixed to the top rail.

In still a further embodiment, and still by way of example only, there is provided an apparatus for filtering water entering a curbside drain comprising a member, means for attaching the member to the curbside drain, and a filter affixed to the frame. The means for attaching the member to the curbside drain is disposed such that water entering the curbside drain passes through the filter.

### BRIEF DESCRIPTION OF THE DRAWINGS

FIG. 1 is a perspective view of a storm drain filter, according to an embodiment of the present invention;

FIG. 2 is a further perspective view of a storm drain filter, according to an embodiment of the present invention;

FIG. 3 is a side view of a storm drain filter, according to an embodiment of the present invention;

FIG. 4 is a front view of a storm drain filter, according to an embodiment of the present invention;

FIG. 5 is a further perspective view of a storm drain filter, according to an embodiment of the present invention;

FIG. 6 is a detailed view of elements of a storm drain filter, according to an embodiment of the present invention;

FIG. 7 is a perspective view of an attaching flange element of the storm drain filter, according to an embodiment of the present invention;

FIG. 8 is a further perspective view of a storm drain filter, according to an embodiment of the present invention;

FIG. 9 is a further side view of a storm drain filter, according to an embodiment of the present invention;

FIG. 10 is a top view of an attaching flange element of the storm drain filter, according to an embodiment of the present invention; and

FIG. 11 is a perspective view of a curb-side storm drain, which may be used with embodiments of the present invention.

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention. Reference will now be made in detail to exemplary embodiments of the invention, examples of which are illustrated in the accompanying drawings. Wherever possible, the same reference numbers will be used throughout the drawings to refer to the same or like parts.

The structure and function of a storm drain will be understood by those skilled in the art, so only a general description is here provided in order to facilitate discussion of embodiments of the invention. Referring to FIG. 11 a typical curb-side drain is an opening provided along the vertical face of road-side curb. Civil engineers design the curb and road with a desired slope so that water typically travels in the channel provided at the road/curb intersection. This channel is further sloped so that water is directed to the drain opening. Upon reaching the drain opening, water then passes from the curb channel through the opening, and into other drainage and piping systems positioned below the road surface. Water is then moved through this drainage system to a desired water control location such as flood control channels or containment ponds. The typical curb-side drain is a concrete structure.

The curb-side drain includes both an outer surface and an inner surface. For example an outer surface may include the curb face 101 and upper surface 102. The inner surface of the curbside drain may also include several surfaces such as inner wall surfaces and an inner ceiling surface. Inner ceiling surface is typically a generally planar and horizontal surface which begins at opening and extends in a generally 90 degree direction the plane of the opening. Ceiling surface may also underlie the sidewalk surface 103. It will also be appreciated by those skilled in the art that a variety of curved surfaces may surround the immediate drain opening itself.

The drain opening 104 may take a variety of shapes; however, it is typically somewhat rectangular in overall shape with curved corners. The opening 104 may have a substantially planar arrangement, and frequently the plane of the opening 104 is not perfectly vertical but is somewhat canted from the vertical.

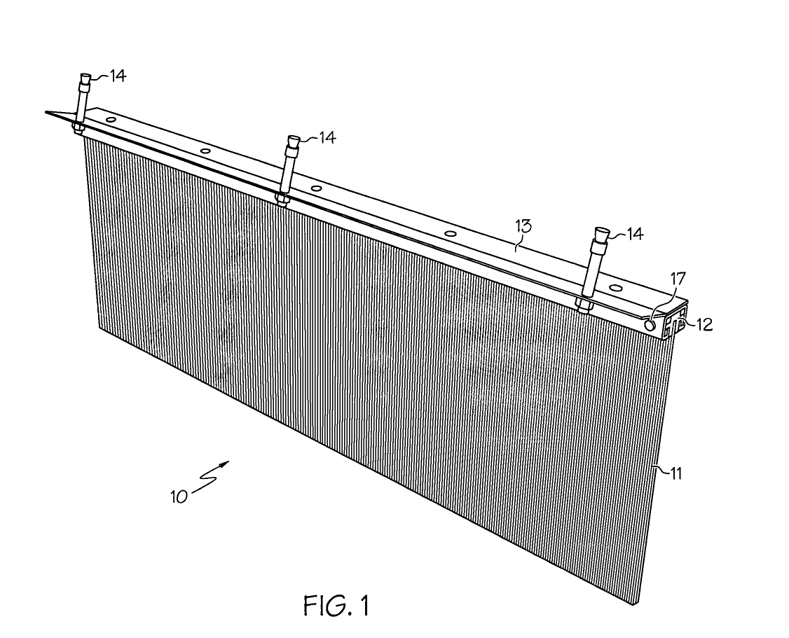

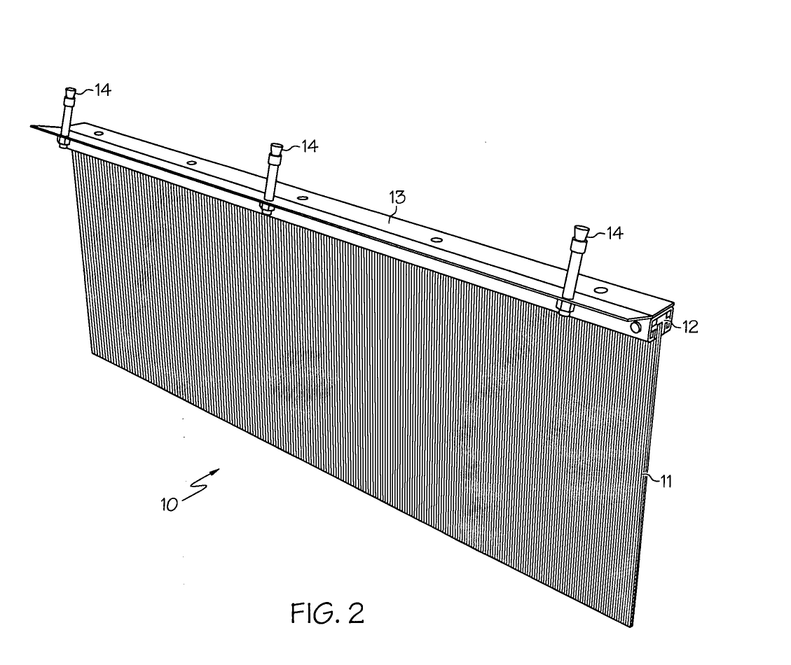

Referring now to FIGS. 1 and 2, there is shown a perspective view of storm drain filter 10, according to a preferred embodiment of the present invention. Filter 10 includes bristles 11, arm 12, frame 13, and bolts 14.

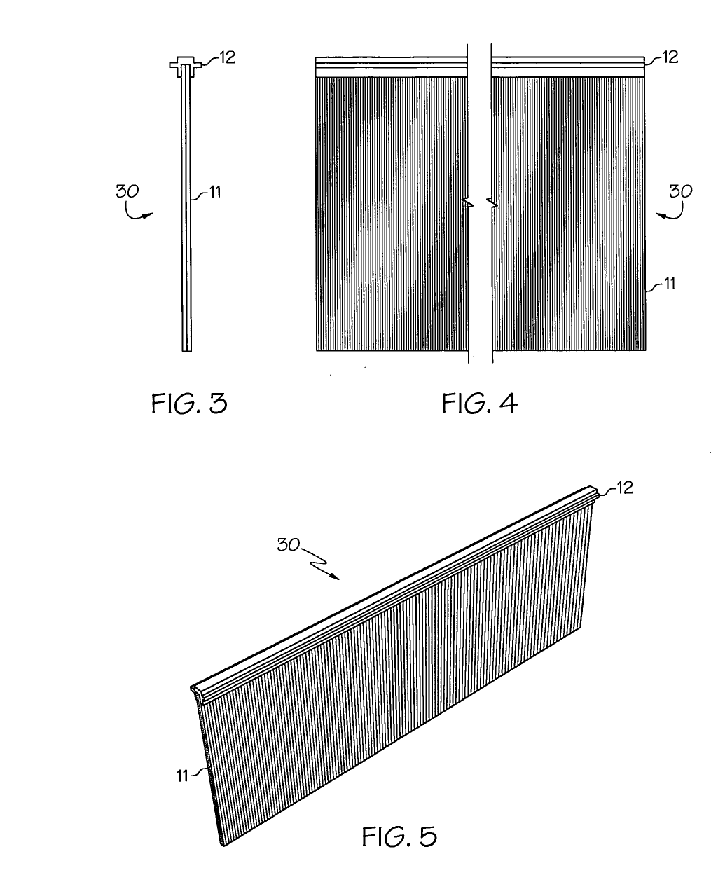

Referring next to FIGS. 3, 4, and 5 there are shown various views of a bristle subassembly 30. Subassembly 30 comprises bristles 11 and attachment arm 12. Bristles 11 include a plurality of individual bristles. Typically, bristles 11 are elongate structures, and ach individual bristle includes a first end and a second end, or a proximal end and a distal end. Preferably bristles 11 are each aligned and oriented in a substantially parallel arrangement and secured at one end to attachment arm 12.

It will be appreciated by those skilled in the art that filter 10 may be used so as to cover, or substantially cover or even partially cover, a storm drain opening 104. Thus, the overall dimension of filter 10 such as the height and width may be selected so as to provide a desired degree of coverage. In a preferred method of usage, filter 10 is dimensioned so that bristles 11 substantially cover the width dimension of a storm drain opening, and in this manner, filter 10 provides a maximum degree of filtering for the water that flows from the curb drain, through the filter, and into the storm drain.

Bristles 11 may comprise any material suitable to filter debris from a stream of water. Preferred materials include fibers of polypropylene, natural materials and synthetic materials.

In one embodiment, filter 10 comprises a single row or layer of bristles. However, in other embodiments, filter 10 may include a plurality of bristles 11 configured in multiple layers or rows with each successive row being positioned behind the former row such that filter 10 is characterized by a thickness greater than the thickness of a single bristle.

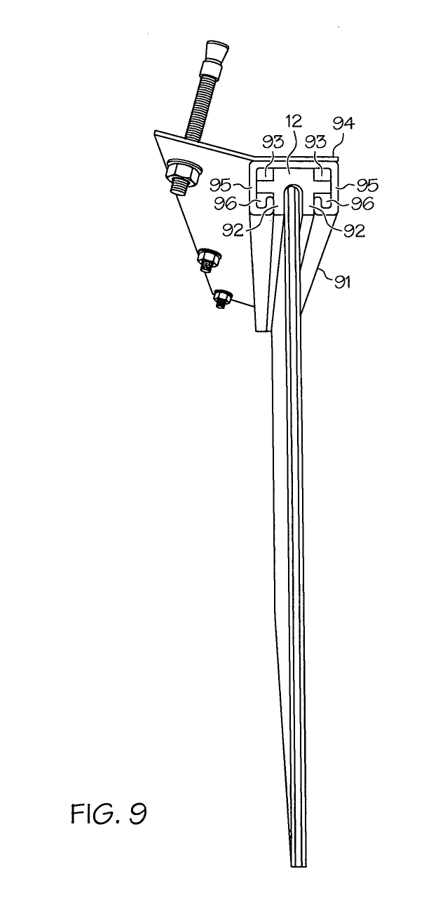

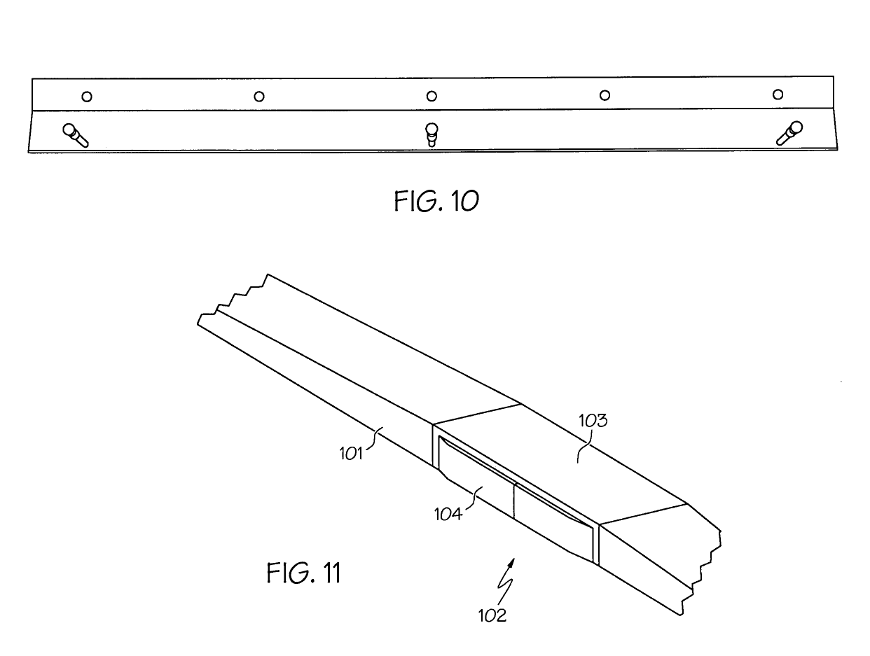

Referring now to FIG. 9, a preferred embodiment of arm 12 is now discussed. In one embodiment arm 12 includes groove 91. Groove 91 is generally shaped so as to receive one end of bristles 11. Further, groove 91 is partially formed by substantially parallel vertical arms 92. Vertical arms 92 can be compressed in order to provide the tension within groove 91 to hold bristles 11 in the desired illustrated arrangement. Vertical arms 92 can be of a desired length in order to a desired degree of holding power for bristles 11. Also shown in FIG. 9 are horizontal arms 93 as part of holding rail 12 which, as further discussed herein, assist in the assembly of filter 10. Horizontal arms 93 each define an end 95 and an under surface 96. Additionally, arm 12 may include upper surface 94. In one embodiment, arm 12 is comprised of an extruded fiberglass, plastic, or thermoplastic material.

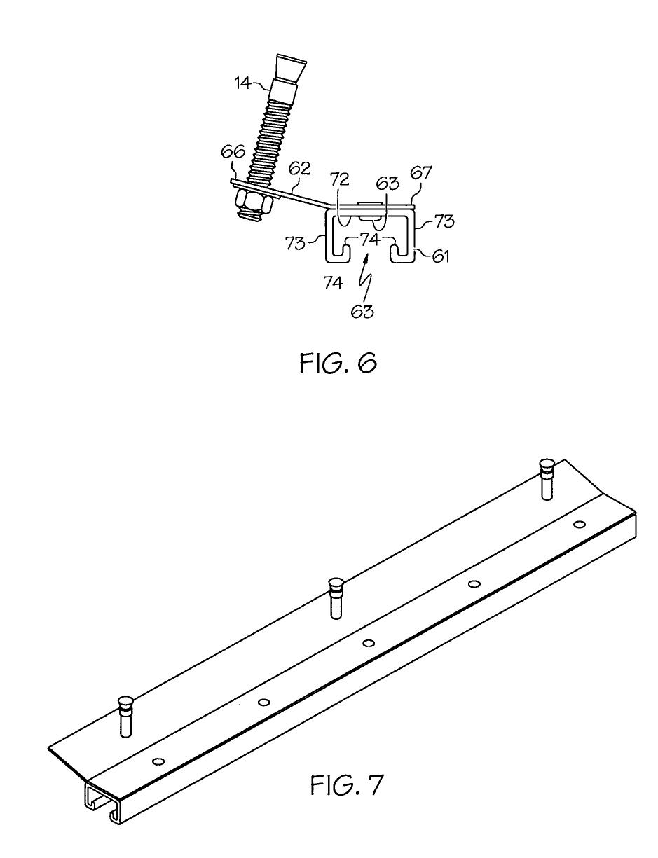

Referring now to FIG. 6, frame 13 includes holding rail 61. Holding rail 61 is preferably formed in a partially square or partially rectangular shape. The preferred embodiment of holding rail 61 includes opening 71, upper surface 72, side walls 73, and rim 74. The function of holding rail 61 is further explained with respect to FIG. 9. Preferably holding rail 61 is configured so that arm 12 can be assembled therein. Upper surface 94 of arm 12 rests against upper surface 72 of holding rail 61. Horizontal arms 93 are structured so that ends 95 of horizontal arms 93 rest against side walls 73. Additionally, the under surface 96 of each horizontal arm rests against rims 74. Additionally, rims 74 rest against vertical arms 92.

FIG. 9 represents a final assembly, and it will be appreciated by those skilled in the art that manufacturing and assembly thereof may be facilitated by initially fabricating holding rail 61 in a slightly oversized shape. Arm 12 can then more readily slide into a desired position within holding rail 61. Once in such a desired position, holding rail 61 can be compressed to firmly engage arm 12. This is one preferred method of assembly.

Referring to FIGS. 1 and 8 a further aspect of the illustrated filter embodiment is now mentioned. Filter 10 may be provided with tensioner 17. Tensioner 17 may comprise a structure such as a pin, screw, bolt, rivet, or the like. Tensioner 17 functions to hold arm 12 within holding rail 61.

Referring again to FIG. 6, an advantageous feature of the illustrated embodiment is here discussed. In the illustrated embodiment, frame 60 includes holding rail 61 and attaching flange 62. Further, holding rail 61 and attaching flange 62 are secured to each other through a plurality of rivets 63, although other structures such as bolts, screws, glue, and the like may also be employed as means for attaching these two structures. Bolts 14 are then secured to attaching flange 62. In the illustrated preferred embodiment, it is noted that attaching flange 62 includes an angle between a first segment 66 of flange 62 and second segment 67 of flange 62. Further, flange 62 is itself preferably of a dimension and material so that it can be somewhat adjusted. The advantage of such a structure relates to the intended usage of the drain filter. Filter 10 can be used effectively by being attached to an inner surface of a curb-side drain. For example, in one intended method of use bolts 14 will be affixed to the drain's inner surface so that filter 10 will hang from that surface. It is anticipated that the drain inner surface may be somewhat rough and uneven. It is further anticipated that the slope or angle of a drain inner surface, relative to the drain opening, may vary from one drain to the next. Thus, it would be desired that a means to attach filter 10 to a drain opening be allowed to adapt to this variation in structures. Referring again to FIG. 6 it will be appreciated that attaching flange 62 can flex from one angle to another. This ability to flex allows filter 10 to be adapted to a variety of drain configurations. Once bolts 14 are affixed to the inner drain surface, an installed can grasp attaching flange 62 and bend or flex attaching flange 62 to a preferred angle so that bristles 11 cover the drain opening to a desired amount. Also preferably, the dimension and material of attaching flange 62 is such that once flange 62 has been bent or flexed to a desired configuration, flange 62 will tend to remain in the new position.

It should also be appreciated that attaching flange 62 can be flexed or bent to accommodate a twist in a curbside drain. Given the irregularity in these structures, it is not expected that a drain will have the same angular relationship at one point, (for example on the left hand side facing the drain) as would be expected on the opposite side (the ride hand side facing the drain). In such irregularly shaped drains, filter 10 is well adapted to be flexed so that one side of the filter can accommodate a desired arrangement, while the opposite side of the filter can be flexed to a different angle, creating a twist in the overall shape of attaching flange 62.

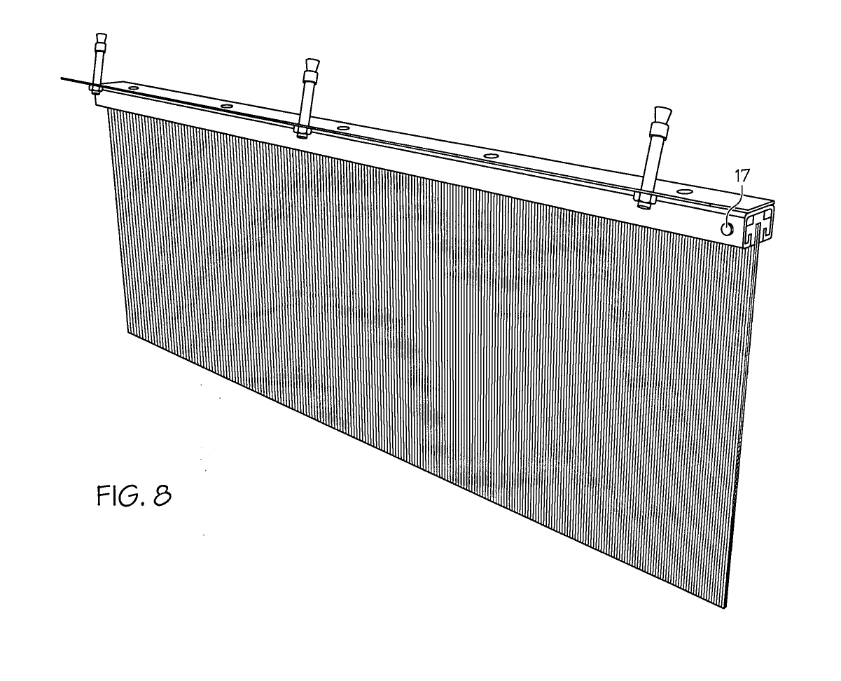

Referring now to FIG. 7 there is shown a preferred embodiment of attaching flange 62 affixed to holding rail 61. However, it should be appreciated that the number of bolts 14 and rivets 63 may differ from the number shown in the illustration. Likewise, while 16 gauge 316 stainless steel is a preferred material, other kinds of materials may also be used.

In operation, filter 10 can be used to filter or screen undesirable materials from a flow of water. Construction sites in particular can give rise to water flows that pick up dirt and debris. When a curb drain is present, the water and water-born pollution will eventually collect and flow in the curb drain. If not prevented, the water and contaminants will pass into the curb drain and storm sewer system. Filter 10 is placed proximate to the drain opening so that bristles 11 partially or substantially cover the drain opening. In this manner water impinges upon filter such that water can pass through filter and into the drain system. However, water-borne contaminants such as rocks, debris, dirt, sand, and the like are prevented from flowing when they impinge the filter.

In a further embodiment, the attachment of filter 10 to an inner surface of a curb-side drain brings frame 13 into contact with that surface. As bolts 14 are tightened, frame 13 moves until it presses against surface. Bolts 14 may be further tightened such that frame flattens out against the curb inner surface so that the angle or curvature that is initially present in frame 13 is lessened. This tensioning of frame 13 can serve the additionally beneficial purpose of biasing frame 13 against nuts and/or bolts so that they are held in place with reduced chance of coming unattached.

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to a particular embodiment disclosed as the best mode contemplated for carrying out this invention, but that the invention will include all embodiments falling within the scope of the appended claims.

What is claimed is:

1. A filtration apparatus for use with a curbside drain comprising:
a frame comprising a holding rail and an attaching flange;
a plurality of concrete bolts affixed to the attaching flange;
a broom filter comprising a plurality of bristles having a proximal end and a distal end;
an arm wherein the plurality of bristles are affixed to the arm at their proximal end;
wherein the arm is secured within the holding rail of the frame;
wherein the bristles extend substantially vertically from the arm.

2. The filtration apparatus according to claim 1 wherein the curbside drain includes an inner surface and wherein the concrete bolts are affixed to the inner surface of the curbside drain so that water passing into the curbside drain passes through the broom filter.

3. The filtration apparatus according to claim 1 wherein the curbside drain comprises an opening and wherein the frame is attached to the curbside drain so that the broom filter substantially covers the opening.

4. The apparatus according to claim 1 further comprising a tensioner affixed to the holding rail.

5. The apparatus according to claim 1 further comprising a plurality of fasteners connecting the holding rail to the attaching flange.

6. The apparatus according to claim 5 wherein the fasteners comprise rivets.

7. The filtration apparatus according to claims 1 wherein the bristles comprise polypropylene fibers.

8. The filtration apparatus according to claim 1 wherein the bristles comprise synthetic fibers.

9. The filtration apparatus according to claim 1 wherein the bristles comprise natural fibers.

10. The filtration apparatus according to claim 1 wherein the frame further comprises at least one side arm affixed to the attaching rail.

11. An apparatus for erosion control comprising:
a frame;
a filter affixed to the frame
bristles connected to the filter; and
means for attaching affixed to the frame.

12. The apparatus according to claim 11 wherein the frame includes a top rail and wherein the attachment means is affixed to the top rail.

13. The filtration apparatus according to claim 11 wherein the bristles comprise polypropylene fibers.

14. The filtration apparatus according to claim 11 wherein the bristles comprise synthetic fibers.

15. The filtration apparatus according to claim 11 wherein the bristles comprise natural fibers.

16. An apparatus for filtering water entering a curbside drain comprising:
a member;
means for attaching the member to the curbside drain; and
a filter affixed to the frame, wherein the filter includes bristles.

17. The apparatus according to claim 16 wherein the means for attaching the member to the curbside drain is disposed such that water entering the curbside drain passes through the filter.

18. The filtration apparatus according to claim 16 wherein the bristles comprise polypropylene fibers.

19. The filtration apparatus according to claim 16 wherein the bristles comprise synthetic fibers.

20. The filtration apparatus according to claim 16 wherein the bristles comprise natural fibers.
